(19) United States
(12) Patent Application Publication
(10) Pub. No.: US 2022/0249987 A1
(43) Pub. Date: Aug. 11, 2022

(54) Water purification filter

(71) Applicant: Kyo-Sun OH, Namyangjusi (KR)

(72) Inventor: Kyo-Sun OH, Namyangjusi (KR)

(21) Appl. No.: 17/591,618

(22) Filed: Feb. 3, 2022

(30) Foreign Application Priority Data
Feb. 5, 2021 (KR) 1020210016704

(51) Int. Cl. B01D 29/58; B01D 29/11; B01D 35/30; C02F 1/00

(52) U.S. Cl. CPC B01D 29/58; B01D 29/117; B01D 35/30; C02F 1/001; B01D 2201/4046; C02F 2201/004; C02F 2307/06; B01D 2201/302; B01D 2201/4038; C02F 2201/003

(57) ABSTRACT

Proposed is a water filter, including filter segments provided by dividing the filter into two or more sections composed of materials or densities that are same or different from each other, and a connection cap mounted between the filter segments, wherein the connection cap communicates with a filter flow path of an anterior filter segment, is closed to a filter flow path of a posterior filter segment, is provided with a closing part at a location between the anterior filter segment and a filter casing, and is provided with a connection cap flow path between the posterior filter segment and the filter casing, thereby allowing the water purified primarily by the anterior filter segment to be drained into the connection cap flow path and then to be discharged through the filter flow path of the posterior filter segment after being processed through a secondary water purification process.

### CROSS REFERENCE TO RELATED APPLICATION

The present application claims priority to Korean Patent Application No. 10-2021-0016704, filed Feb. 5, 2021, the entire contents of which is incorporated herein for all purposes by this reference.

### BACKGROUND OF THE INVENTION

### Field of the Invention

The present disclosure relates to a water filter and, more particularly, to a water filter capable of improving water purification efficiency of the filter housed inside a shower head or a water purifier.

### Description of the Related Art

In general, a long cylindrical water filter is mounted on a shower head and a water purifier in a bathroom or in a kitchen and is configured to cleanly filter out harmful substances such as rust or foreign substances mixed in the tap water. Accordingly, when the water filter is contaminated by harmful substances in tap water due to long-term use of the shower head, the water filter may be replaced with a new water filter.

However, such a conventional water filter is configured to replace the water filter with a new water filter when the water filter, which has a long cylindrical shape and mounted inside the filter casing of the shower head or the water purifier, is contaminated due to the long-term use thereof. In this case, depending on users, it is very ambiguous to set the exact replacement time of the water filter, resulting in confusion. That is, depending on the users, when the water filter is replaced with a new one too late, there is a defect that contaminated water is used, and when the water filter is replaced too early, there is a waste of replacing the water filter more than necessary.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and objectives of the present disclosure are allowing water to go through several water purification processes step-by-step within a limited capacity of the existing water filter, thereby maximizing water purification efficiency, and allowing the filters to be selectively replaced with a new one according to a degree of contamination caused by the water purification processes.

In order to achieve the above objectives, the water filter of the present disclosure may be provided, the water filter including: a first support cap closed to a filter flow path of a filter, formed with a flow path between the filter and a filter casing, and mounted on a first end of the filter that may have the filter flow path at a central portion thereof and may be mounted inside the filter casing; and a second support cap closed to a gap between the filter and the filter casing, formed with a flow path communicating with the filter flow path, and mounted on a second end of the filter, so that inlet water introduced through the flow path of the first support cap may be purified by the filter and may be then discharged through the filter flow path and the flow path of the second support cap, the water filter further including: filter segments provided by dividing the filter into two or more sections composed of materials or densities that may be same or different from each other; and a connection cap mounted between the filter segments, wherein the connection cap may communicate with a filter flow path of an anterior filter segment, may be closed to a filter flow path of a posterior filter segment, may be provided with a closing part at a location between the anterior filter segment and a filter casing, and may be provided with a connection cap flow path between the posterior filter segment and the filter casing, thereby allowing the water purified primarily by the anterior filter segment to be drained into the connection cap flow path and then to be discharged through the filter flow path of the posterior filter segment after being processed through a secondary water purification process by the posterior filter segment. Accordingly, the water may be allowed to undergo the water purification process step-by-step by each of the filter segments, and each of the filter segments may be allowed to be selectively replaced with a new one according to a degree of contamination, so that water purification efficiency may be significantly improved.

As described above, the water filter of the present disclosure allows the water purified primarily by the anterior filter segment to be drained into the connection cap flow path and then to be discharged through the filter flow path after being processed through a secondary water purification process by the posterior filter segment. Accordingly, the water is allowed to go through the water purification process step-by-step by each of the filter segments, and each of the filter segments is allowed to be selectively replaced with a new one according to a degree of contamination, so that water purification efficiency can be significantly improved.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an external perspective view of an exemplary embodiment of a shower head to which the present disclosure is applied;

FIG. 2 is a partial longitudinal sectional view showing an internal structure of the same shower head;

FIG. 3 is an external perspective view of a connection cap of the present disclosure;

FIGS. 4 to 6 are partial longitudinal sectional views showing internal configurations of another embodiment of the present disclosure;

FIGS. 7 and 8 are partial longitudinal sectional views showing configurations of still another embodiment of the present disclosure; and

FIGS. 9 to 11 are perspective views showing detailed configurations of still another embodiment of the present disclosure.

### DETAILED DESCRIPTION OF THE INVENTION

Hereinbelow, exemplary embodiments of the present disclosure will be described in detail with reference to the accompanying drawings.

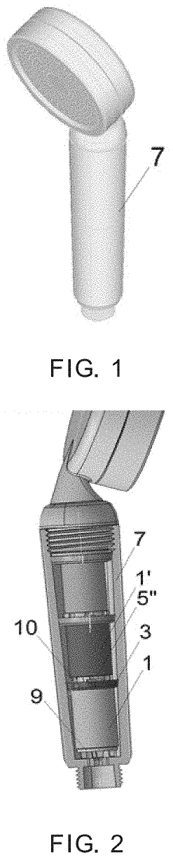

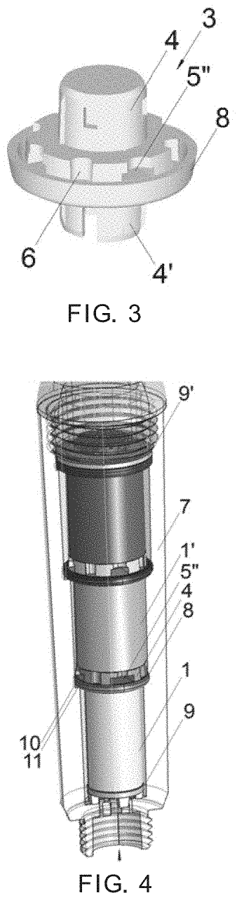

FIG. 1 is an external perspective view of an exemplary embodiment of a shower head to which the present disclosure is applied; FIG. 2 is a partial longitudinal sectional view showing an internal structure of the same shower head; and FIG. 3 is an external perspective view of a connection cap of the present disclosure.

Like a conventional water filter, a water filter of the present disclosure includes: a first support cap closed to a filter flow path, formed with a flow path between a filter and a filter casing, and mounted on an end of the filter having a filter flow path provided at a central portion and mounted inside the filter casing; and a second support cap closed to a gap between the filter and the filter casing, formed with a flow path communicating with the filter flow path, and mounted on an opposite end of the filter. Unlike the conventional water filter, the water filter of the present disclosure includes: filter segments 1 and 1′ provided by dividing the filter into two or more sections composed of materials or densities that are same or different from each other; and a connection cap 3 mounted between the filter segments 1 and 1′.

In addition, the connection cap 3 is provided with insertion rods 4 and 4′ in upper and lower sides, respectively, and the insertion rods are inserted into and mounted on the inside of the filter paths 5 and 5′, respectively, of the anterior and posterior filter segments 1 and 1′.

In addition, the connection cap 3 communicates with a filter flow path 5 of an anterior filter segment 1, is closed to a filter flow path 5′ of a posterior filter segment 1′, is provided with a closing part 8 between the anterior filter segment 1 and a filter casing 7, and is provided with a connection cap flow path 5″ between the posterior filter segment 1′ and the filter casing 7.

In addition, packing 10 of various types and materials may be optionally provided on the closing part 8 and closely maintain the water tightness between the filter casing 7 and the closing part 8 of the connection cap 3, thereby not allowing the water purified by the anterior filter segment 1 to be introduced between the posterior filter segment 1′ and the filter casing 7 without going through a water purification process.

Unexplained reference numerals 9 and 9′ are the first support cap and the second support cap, respectively.

The water filter of the present disclosure configured as described above is composed of the filter segments 1 and 1′ that the filter may be divided into two or more sections, whereby the water purified primarily by the anterior filter segment 1 is drained into the connection cap flow path 5″ and then to be discharged through the filter flow path 5′ after being processed through a secondary water purification process by the posterior filter segment 1′. In this case, the water is allowed to go through the water purification process step-by-step by each of the filter segments 1 and 1′, and each of the filter segments 1 and 1′ is allowed to be selectively replaced with a new one according to a degree of contamination, so that water purification efficiency may be significantly improved.

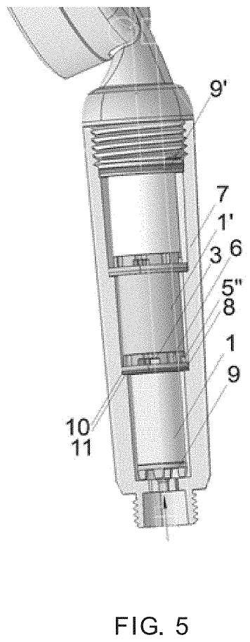

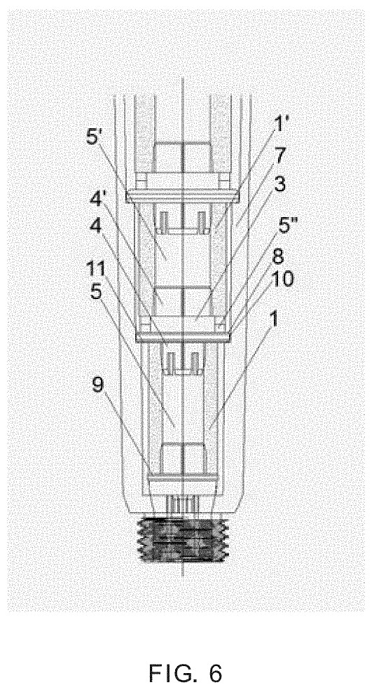

FIGS. 4 to 6 are partial longitudinal sectional views showing internal configurations of another embodiment of the present disclosure, wherein the closing part 8 of the connection cap 3 is allowed to be seated on a support step 11 formed on an inner circumferential surface of the filter casing 7, whereby the posterior filter segment 1′ and the connection cap 3 may be more stably seated on the inner circumferential surface of the filter casing 7.

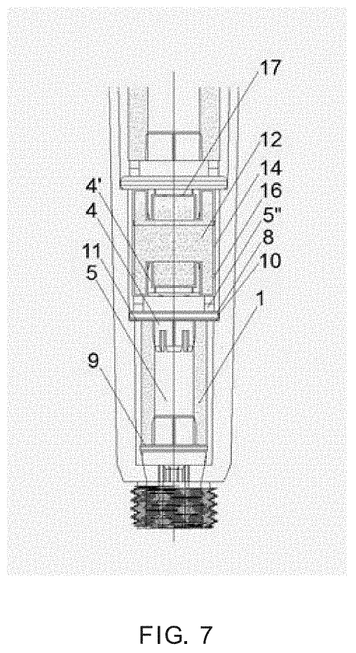

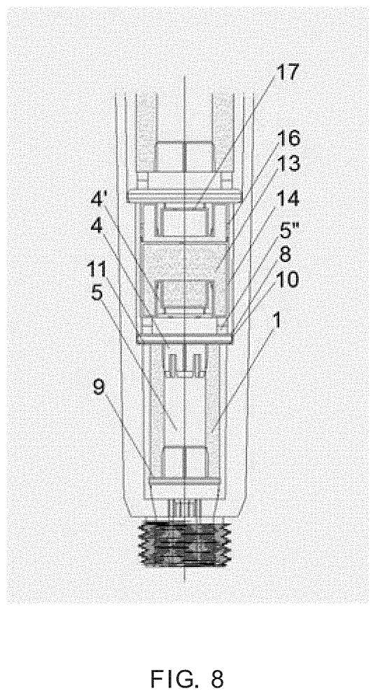

FIGS. 7 and 8 are partial longitudinal sectional views showing configurations of still another embodiment of the present disclosure, wherein a functional material segment 14 is provided between the filter segments 1 and 1′, which are formed by dividing the filter into two or more sections. The functional material segment 14 contains therein a functional material 12 such as a known far-infrared ceramic, an antibacterial ball, and a magnetic material, or a vitamin C 13, so the component discharged from the functional material 12 or the vitamin C 13 may be dissolved in the water before the water is discharged through the drain part 17. Here, it is noted that the functional material segment 14 may be provided in front of the anterior filter segment 1 or in rear of the posterior filter segment 1′.

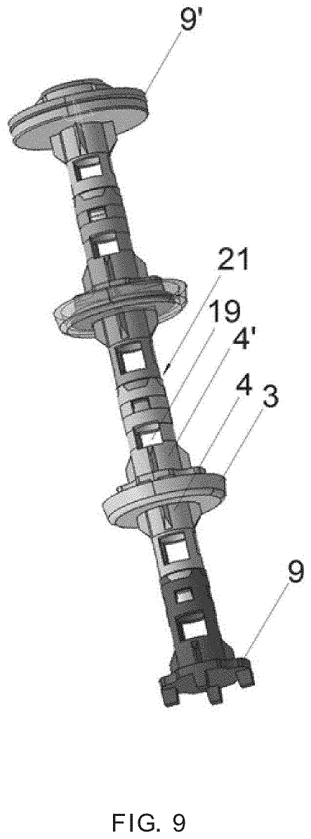

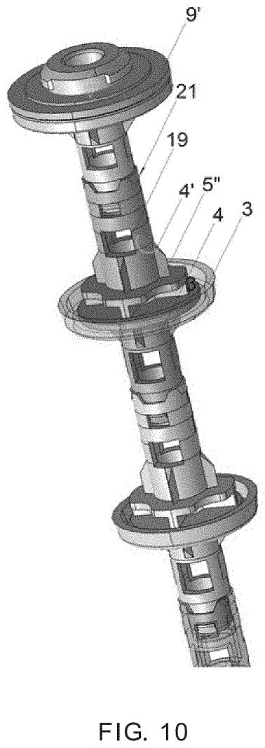

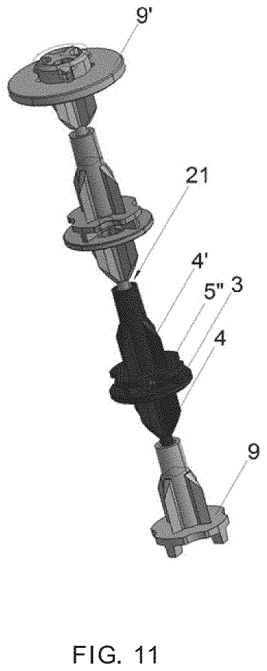

FIGS. 9 to 11 are perspective views showing detailed configurations of still another embodiment of the present disclosure. Water passing holes 19 are provided in the insertion rods 4 and 4′ of the connection cap 3 and vertically extend in an elongated manner in a state of being spaced apart from inner surfaces of the filter segments 1 and 1′ so as to be integrally connected with an adjacent connection cap 3 by a connecting part 21 which is assembled by interference fit, hooking, or the like. The divided filter segments 1 and 1′ are integrally assembled to each other by the connecting part 21 in an integral manner, to become one filter. Upon assemblage or replacement of the filter segments 1 and 1′, the filter segments 1 and 1′ in a state of being integrally coupled with each other may be handled more stably without separation thereof. As the insertion rods 4 and 4′ of the connection cap are spaced apart from the inner surfaces of the filter segments 1 and 1′, the water purification efficiency can be improved without reduction of the water purification area due to direct contact of the filter segments 1 and 1′ with the insertion rods 4 and 4′.

Therefore, according to the present disclosure, the water filter is composed of the filter segments 1 and 1′ that the filter is divided into two or more sections, and the connection cap 3 mounted between the filter segments 1 and 1′. Here, the connection cap 3 communicates with the filter flow path 5 of the anterior filter segment 1, and is closed to the filter flow path 5′ of the posterior filter segment 1′. The connection cap 3 is also provided with the closing part 8 between the anterior filter segment 1 and the filter casing 7, and with the connection cap flow path 5″ between the posterior filter segment 1′ and the filter casing 7, thereby allowing the water purified primarily by the anterior filter segment 1 to be drained into the connection cap flow path 5″ and then to be discharged through the filter flow path 5′ after being processed through the secondary water purification process by the posterior filter segment 1′. In this case, the water is allowed to go through the water purification process step-by-step by each of the filter segments 1 and 1′, and each of the filter segments 1 and 1′ is allowed to be selectively replaced with a new one according to the degree of contamination, so that there is an advantage that water purification efficiency may be significantly improved.

In the above, even though the present disclosure has been described based on specific embodiments, the above embodiment is only one example for explaining the technical idea of the present disclosure, and the technical scope of the present disclosure is not limited to the above embodiment only.

For example, in the above embodiment, the method of allowing water to be purified while moving from the outside to the inside of the filter segments 1 and 1′ is illustrated. However, on the contrary, the same function may be exhibited even in a way that the water is purified while moving from the inside to the outside of the filter segments 1 and 1′. Accordingly, the movement path of the water formed in the first and second support caps 9 and 9′ and the connection cap 3 may also be applied reversely to that of the above embodiment. In addition, the functional material 12 such as vitamin C 13 may even be built into the filter segments 1 and 1′. In addition, all changes are included in the equivalency of the meaning, and the scope of the technical spirit and claims of the present disclosure.

What is claimed is:

1. A water filter, comprising: a first support cap closed to a filter flow path of a filter, formed with a flow path between the filter and a filter casing, and mounted on a first end of the filter that has the filter flow path at a central portion thereof and is mounted inside the filter casing; and a second support cap closed to a gap between the filter and the filter casing, formed with a flow path communicating with the filter flow path, and mounted on a second end of the filter, so that inlet water introduced through the flow path of the first support cap is purified by the filter and is then discharged through the filter flow path and the flow path of the second support cap, the water filter further comprising:
filter segments (1 and 1′) provided by dividing the filter into two or more sections composed of materials or densities that are same or different from each other; and
a connection cap (3) mounted between the filter segments (1 and 1′),
wherein the connection cap (3) communicates with a filter flow path (5) of an anterior filter segment (1), is closed to a filter flow path (5′) of a posterior filter segment (1′), is provided with a closing part (8) at a location between the anterior filter segment (1) and a filter casing (7), and is provided with a connection cap flow path (5″) between the posterior filter segment (1′) and the filter casing (7), thereby allowing the water purified primarily by the anterior filter segment (1) to be drained into the connection cap flow path (5″) and then to be discharged through the filter flow path (5′) of the posterior filter segment (1′) after being processed through a secondary water purification process by the posterior filter segment (1′),
insertion rods (4 and 4′) are provided in upper and lower sides of the connection cap (3) respectively, and inserted into and mounted on insides of the filter paths (5 and 5′) of the anterior and posterior filter segments (1 and 1′), and
the insertion rods (4 and 4′) vertically extend from upper and lower sides of the connection cap (3) so as to be integrally connected with an adjacent connection cap (3) by a connecting part 21, and upon assemblage or replacement of the filter segments 1 and 1′, the filter segments 1 and 1′ in a state of being integrally coupled with each other can be handled more stably without separation thereof.

2. The water filter of claim 1, wherein water passing holes (19) are formed in the insertion rods (4 and 4′) of the connection cap (3) , allowing the insertion rods (4 and 4′) to be spaced apart from inner surfaces of the filter segments (1 and 1′), thereby improving the water purification efficiency without reduction of water purification area due to direct contact of the filter segments (1 and 1′) with the insertion rods (4 and 4′).
